(19) United States
(12) Patent Application Publication
(10) Pub. No.: US 2007/0168981 A1
(43) Pub. Date: Jul. 19, 2007

(54) Online creation of object states for testing

(75) Inventors: Carlos Pacheco, Brighton, MA (US); Shuvendu K. Lahiri, Redmond, WA (US); Thomas Jaudon Ball, Mercer Island, WA (US)

Correspondence Address: KLARQUIST SPARKMAN LLP, 121 S.W. SALMON STREET, SUITE 1600, PORTLAND, OR, 97204, US

(73) Assignee: Microsoft Corporation, Redmond, WA (US)

(21) Appl. No.: 11/326,938

(22) Filed: Jan. 6, 2006

(51) Int. Cl. G06F 9/44

(52) U.S. Cl. 717/124

(57) ABSTRACT

An application is tested by using the public interface to determine the possible class types, choosing a class type at random, and then finding a constructor which creates an object of that class type. A method that takes the object is selected, and input values for the method are selected. The object is then created using the constructor and any other required methods. The selected method is called on the object using the selected inputs. If calling the method with the object changes the state of the object or an associated object, then the object and method are extended, sometimes by adding another method call to the existing method call(s), creating a new plan, and the new plan is then tested. If the state is not changed, then the object and the method are not further tested.

### COPYRIGHT AUTHORIZATION

A portion of the disclosure of this patent document contains material which is subject to copyright protection. The copyright owner has no objection to the facsimile reproduction by anyone of the patent disclosure, as it appears in the Patent and Trademark Office patent file or records, but otherwise reserves all copyright rights whatsoever.

### BACKGROUND

In object-oriented programming, programs are written as a collection of classes. An instance of a class is an object. The use of classes allows the underlying programs to encapsulate data, exhibit polymorphism, and (generally) allow inheritance. Data encapsulation can also be thought of as data hiding. Classes hide their internal composition, structure and operation. They expose their functionality to client programs that utilize the class only through one or more interfaces. An interface defines the actual methods with their data types that a class uses to interact with client programs. However, the implementation of the class is defined separately and generally cannot be modified by a client program through the interface.

The advantage of using data encapsulation comes when the implementation of the class changes but the interface remains the same. For example, a method to sort members of an array may be replaced internally with a different, more efficient sort. If the interface does not change, then code which utilizes the sort will still be valid.

Inheritance allows classes to easily create objects which are specialized types of existing objects—new object types can be defined which share and extend the behavior of existing objects without the need to reimplement existing behavior. A child class inherit the properties of its parent class, and is free to add features if its own. Some object-oriented languages extend the idea of inheritance to allow multiple inheritance. Multiple inheritance allows a class to inherit the same class more than once. This is useful when a class has two or more sets of behavior a class should require.

Polymorphism is the ability for different types of objects to invoke the same method and have the method produce the appropriate different results. The classic example is “area.” A base class “shape” can have different derived methods (such as “rotate”, “changecolor”, etc.) for different shape classes, such as “circle” “square”, “triangle”, etc. The same rotate method can then be applied to any shape object and return the correct results. The base class does not need to know, and often doesn't know, the type of the object that invokes the method until runtime. This is called dynamic binding.

The strengths of object-oriented programming, that is, encapsulation, inheritance, and polymorphism lead to difficulties in testing these programs above and beyond the difficulties in testing ‘procedure-oriented” software programs. Classes are instantiated dynamically as objects. The state of the object along with implementation details are all hidden from the user, but can be accessed and modified by its methods. This encapsulation, while giving confidence that a user will not be able unexpectedly change the state of an object, creates a problem with observability; that is, the only way to observe the state of an object is to call its method. Testing requires knowing the state of the program, and knowing the behavior that results from such a state. However, as so many details are hidden from an observer, the number of potential states, and when the object has reached its possible states is often far from clear. Changing the state of an object has other side effects, as well. For example, it can also potentially mutate the state of the objects used as parameters to the method invocation, and it can return a new object. Polymorphism allows many possible object bindings, the specific binding depending on the specific (hidden) state of the object, each of which, it goes without saying, should be tested. Inheritance compounds the problem, greatly increasing the possible states, of an object each possible inheritance path representing at least one, and potentially many, states.

Methods and systems are needed to test applications written in object-oriented languages with hidden object states.

### SUMMARY

Constructing a test input for an object-oriented module can be performed by creating a sequence of method invocations (and parameters to the invocations) that create a set of objects, mutate their state, and finally use the resulting object states as inputs to the tested component. Existing approaches to the method sequence generation problem typically operate offline: the method sequences are derived statically, compiled, and then only after compilation are executed.

In one disclosed embodiment, plans are automatically created, run, and then examined. The plans comprise templates that will create an object of a specified class type. When the plan is run, one method may be called, or a series of methods may be called sequentially, with the final method producing an object of the specified class type. After the plan is run, the state of the objects within the program are examined. If creating the specified object changed the state of one of the objects in the program, then the method(s), and/or object(s) within the plan are considered interesting, and are tested more fully. This testing more fully comprises extending the original plan such that a new method call is added to the plan, and if necessary, inputs to the call are also generated. The method may be chosen randomly from among the public methods of the program. If creating the specified object generated an exception, then the object and/or the method are not tested further, but the exception itself and the code that generated the exception can be saved for further study. The extended plan is then added to a list of available plans, and a new plan from among the list of available plans is selected and run.

In another embodiment described herein, a class type is selected online, using the public interface of a target application to be tested. The portion of application code needed to invoke an object of that type is determined, and then run. If running the code produces a state change within the object or within an object modified by the method that invoked the object, then the object, the method, and the inputs and outputs to the method that invoked the object are considered interesting, modifications are made to the method that called the object, or to an associated method, and then the modified code is rerun.

The foregoing and other objects, features, and advantages of the invention will become more apparent from the following detailed description, which proceeds with reference to the accompanying figures.

### BRIEF DESCRIPTION OF THE DRAWINGS

FIG. 1 is a diagram depicting a general-purpose computing device constituting an exemplary system for implementing the disclosed technology.

FIG. 2 is a flow diagram illustrating an exemplary method of creating object states for testing.

FIG. 3 is a diagram relating an exemplary interface to its transformer.

FIG. 4 is a diagram extending a class shown in FIG. 3 by showing examples of creation of an exemplary object.

FIG. 5 is pseudo-code showing an exemplary search algorithm used to explore the state space of an application in conjunction with which described embodiments may be implemented.

FIG. 6 is an operational flow diagram illustrating an exemplary method to test an object-oriented program in conjunction with which described embodiments may be implemented.

FIG. 7 is a block diagram illustrating an exemplary object-oriented tester system with which described embodiments may be implemented.

FIG. 8 is an operational flow diagram illustrating an exemplary method to test an object-oriented program in conjunction with which described embodiments may be implemented.

### DETAILED DESCRIPTION

### Computing Environment

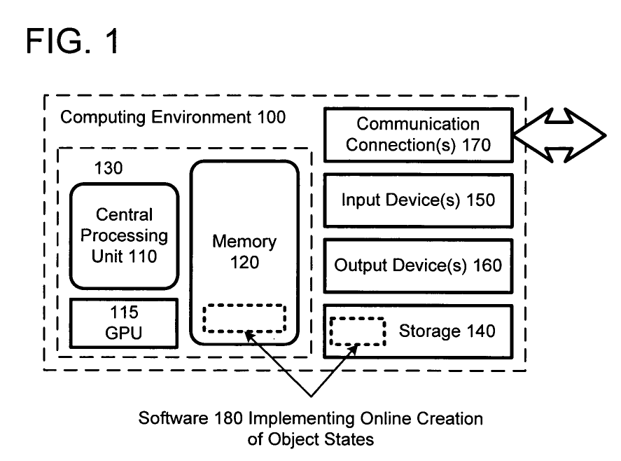

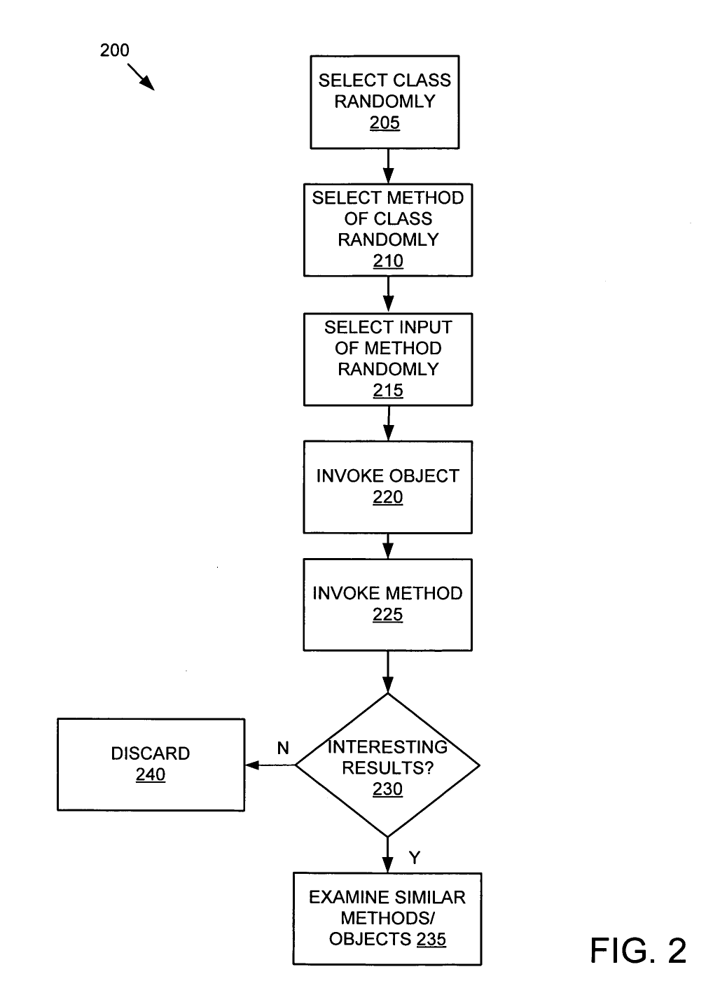

FIG. 1 and the following discussion are intended to provide a brief, general description of an exemplary computing environment in which the disclosed technology may be implemented. For instance, any of the functionalities described with respect to creating object states in FIG. 2 can be implemented in such a computing environment. Although not required, the disclosed technology was described in the general context of computer-executable instructions, such as program modules, being executed by a personal computer (PC). Generally, program modules include routines, programs, objects, components, data structures, etc., that perform particular tasks or implement particular abstract data types. Moreover, the disclosed technology may be implemented with other computer system configurations, including hand-held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

FIG. 1 illustrates a generalized example of a suitable computing environment 100 in which described embodiments may be implemented. The computing environment 100 is not intended to suggest any limitation as to scope of use or functionality of the invention, as the present invention may be implemented in diverse general-purpose or special-purpose computing environments.

With reference to FIG. 1, the computing environment 100 includes at least one central processing unit 110 and memory 120. In FIG. 1, this most basic configuration 130 is included within a dashed line. The central processing unit 110 executes computer-executable instructions and may be a real or a virtual processor. The environment 100 further includes the graphics processing unit GPU at 115 for executing such computer graphics operations as vertex mapping, pixel processing, rendering, and texture mapping. In a multi-processing system, multiple processing units execute computer-executable instructions to increase processing power and as such the GPU and CPU can be running simultaneously. The memory 120 may be volatile memory (e.g., registers, cache, RAM), non-volatile memory (e.g., ROM, EEPROM, flash memory, etc.), or some combination of the two. The memory 120 stores software 180 implementing the described methods of creating object states and using said object state to test object oriented applications.

A computing environment may have additional features. For example, the computing environment 100 includes storage 140, one or more input devices 150, one or more output devices 160, and one or more communication connections 170. An interconnection mechanism (not shown) such as a bus, controller, or network interconnects the components of the computing environment 100. Typically, operating system software (not shown) provides an operating environment for other software executing in the computing environment 100, and coordinates activities of the components of the computing environment 100.

The storage 140 may be removable or non-removable, and includes magnetic disks, magnetic tapes or cassettes, CD-ROMs, CD-RWs, DVDs, or any other medium which can be used to store information and which can be accessed within the computing environment 100. The storage 140 stores instructions for the software 180 implementing the described methods of creating object states and using the object states to test object oriented applications.

The input device(s) 150 may be a touch input device such as a keyboard, mouse, pen, or trackball, a voice input device, a scanning device, touchscreen, or another device that provides input to the computing environment 100. For audio, the input device(s) 150 may be a sound card or similar device that accepts audio input in analog or digital form, or a CD-ROM reader that provides audio samples to the computing environment. The output device(s) 160 may be a display, printer, speaker, CD-writer, or another device that provides output from the computing environment 100.

The communication connection(s) 170 enable communication over a communication medium to another computing entity. The communication medium conveys information such as computer-executable instructions, compressed graphics information, or other data in a modulated data signal. These connections may include network connections, which may be wireless connections, may include dial-up connections, and so on.

Computer-readable media are any available tangible media that can be accessed within a computing environment. By way of example, and not limitation, with the computing environment 100, computer-readable media include memory 120, storage 140, communication media, and combinations of any of the above.

### Overview

As explained above, the high level of abstraction and data hiding in object-oriented programming creates difficulties in reaching many possible object states. Previously, attempts have been made to reach these dusty nooks and crannies by procedure known as monkey-testing, where test inputs are randomly created. However, an obscure object state may require a specific, long set of inputs to reach; to find such a state by generating random strings of inputs is computationally unlikely. The described techniques use both random and guided generation of inputs combined with feedback to guide test searches toward new object states that can exercise different behaviors within a block of program code. These testing techniques can be implemented to be fully automatic, though other implementations which include user input are envisioned. The search of new object states can be thought of as an iterative process of applying transformers (or rules) to existing objects to create new (or updated) objects. Because a method invocation can mutate the state of multiple objects (e.g. the method's receiver, parameters, and return value), a method can be thought of as a rule that takes an input vector of objects and yields an output vector of (possibly) updated objects. To search the space of objects, the rules are applied to existing objects. The search is pruned by detecting vector elements (objects) that are redundant or illegal, using a set of predetermined filters. The search is guided by favoring the application of some transformers over others, based on heuristic criteria.

FIG. 2 shows 200 an overview of an exemplary embodiment of a method of such an iterative testing technique. A program written in an object-oriented language comprises a number of classes. Each class possesses a public interface through which it will be tested. This interface defines the methods and the inputs to the methods of each class. Turning to FIG. 2, at process block 205 a class is chosen to test. The class may be chosen randomly, as is indicated in FIG. 2, but it also may be chosen by how frequently it appears in the program code, or another method may be used. Once a class is chosen, then a method within that class is chosen, as shown at process block 210. Similar to the class, the method can be chosen randomly, or using some other heuristic. If the method chosen requires inputs, then they are chosen, (randomly, or using some other technique) as well, as shown at process block 215.

At process block 220, an object of the class is then invoked. The object may be invoked by an appropriate constructor, or may be already existing in memory. At process block 225 the method is then invoked on the object using the input(s). At this point, the behavior of the program is examined, and based on the behavior, the test is modified to add method calls that appear likely to reach untested object states. At decision block 230, the results of the method invocation are checked. In an exemplary system, the possible results are sorted into three different sets. If the method call led to an exception being thrown, then this method-object set is considered uninteresting for purposes of extending this object plan. A plan is the sequence of method calls and values that led to this specific state. However, the exception thrown may lead to knowledge about problems with the underlying computer code, and so the method object set is saved for later study. If the method call on the object led to a null object being returned, then this method object set is also considered uninteresting for purposes of extending this plan. However, that the null state exists at this point might be considered inherently interesting, as it may indicate a problem with the hidden, internal workings of the method, and so the plan whose invocation generated the null state can be saved for further reference.

Otherwise, the object is examined to see if its state has changed. If the method call led to the state of an object associated with the method not being changed, then this behavior is considered uninteresting, and this method-object plan is flagged as not being worth any more examination 240. However, if the state of the object did change, then the method-object plan is considered interesting 235, and other similar methods and objects are examined for interesting behavior.

If the method-object pair was considered interesting 235, then its plan may be extended by having the object call a new method, by having the object call the same method with a new parameter, and so forth. The extended plan is then considered a new plan, and is placed in a list of potential plans. Methods to extend such plans are discussed in greater detail in the section “Extending Plans.”

A new plan is then chosen to be run from the list of potential plans. If the initial plan was considered uninteresting because it threw an exception, did not produce a state change, or for some other reason, then it is not extended, and so is not placed in the list of potential plans.

Initially, a list of plans may be provided that construct objects or invoke methods of objects. Enough plans are initially provided, generally, to allow the process to continue automatically, with new plans being generated from existing plans that lead to interesting behavior, and plans that do not lead to interesting behavior being dropped from the list of potential plans.

### Object-Creation Search

A test input in an object-oriented unit test typically consists of a sequence of method invocations. These create new objects whose effect is, similarly, to create new objects (using constructor method invocations) and which then mutate the states of the objects via subsequent method calls. In general, a method can have a number of side effects in addition to mutating the state of its receiver—it can return a new object (or primitive value), and it can mutate the state of the objects used as parameters to the method invocation.

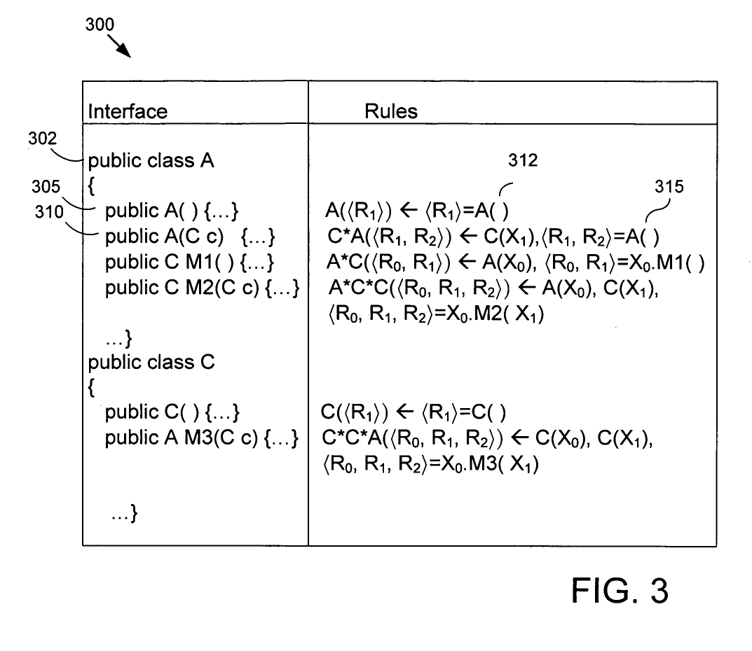

In addition, reference parameters to a method can be aliased (if a method takes two objects of the same type, we can pass the same object reference for both parameter slots), they can be null, or they can themselves have been created and mutated through previous sequences of method calls. An exemplary implementation models the different ways that object states can be created and mutated through sequences of method invocations. To this end, methods can be thought of as rules, and the creation of objects can be thought of as an iterative process of applying rules to existing objects to create new (or updated) objects. FIG. 3 shows two classes, written in C#, and transformers (rules) derived from their interfaces.

To simplify some of the rules, each entity with the subscript 0 represents the type of the class of the method, subscripts 1 through the number of parameters of the method represent the object associated with the respective parameter, and the entity with the subscript equal to the number of parameters plus 1 represents the return entity. So, for example, for each method, R₀ is an object class type, the first object passed into the class is R₁, the second is R₂, through the number of parameters in the class, and R_{(number of parameters+1)} represents the return object. Each of these objects can potentially be modified by the method, and so must be represented. For example, Class A 302 in FIG. 3 has a constructor (a rule for creating an object of type A) A( ) 305 that takes no arguments. Its rule 312 is A(z,900 R₁ [symbol] )← [symbol] (R₁)=A( ). As A is a constructor, there is no class type R₀, nor is there an argument list. Therefore, the first and only rule is R₁, the return type, which is type A. Class A has another constructor, A(C c) 310, that takes a single argument of class C. Constructor A(C c) 310 yields a rule for creating an object of class A from an object of class C: However, invocation of this constructor may lead to a side effect on the object of class C. This is represented as a transformer 315 which shows a rule that takes an object of class C as input (C(X₁)) and yields an output vector C*A( [symbol] R₁, R₂ [symbol] ) that shows the argument object R₁ (of type C, the first type in the typelist C*A that precedes the list of rules in the transformer 315) followed by the return object R₂, which is of type A (the second type in the typelist C*A). The method M2 is of type A (the first type in the typelist A*C*C), which is represented as R₀, has the argument C (the second type in the typelist A*C*C), which is represented as R₁, and returns a value of type C (the third type in the typelist A*C*C), represented as R₂. Each of the objects of these types can be modified by method M2.

In general, consider a method m of class T₀ that takes as input a list of arguments with types T₁, . . . , Tₖ respectively and has a return type Tₖ₊₁. Let T₀* . . . *Tₖ₊₁ be a compound type that represents the type of a vector of objects of types T₀, . . . , Tₖ₊₁ respectively. The method m yields a rule that produces a vector of k+2 output objects. This first rule can be expressed simply using a Datalog-like notation:

$${T}_{0}^{*} … {T}_{k + 1}^{*} ( {R}_{0} , … , {R}_{k + 1} ) ← {T}_{0} ( {X}_{0} ) , … {T}_{k} ( {X}_{k} ) , ( {R}_{0} , … , {R}_{k + 1} ) = {X}_{0} \cdot m ( {X}_{1} , … , {X}_{k} )$$

where Xᵢ represents a variable that will bind against an object of type Tᵢ. Variable Rₖ₊₁ is a “result” variable of type Tₖ₊₁ that represents the return value of the invocation of method m on the objects X₀, . . . , Xₖ. The variables R₀, . . . , Rₖ represent the state of the object X₀, . . . , Xₖ after the method returns. The rule yields the vector of objects R₀, . . . , Rₖ₊₁ of type T₀, . . . ,Tₖ₊₁. The fact Tᵢ(Xᵢ) indicates that the object Xᵢ has type Tᵢ. For static methods (including constructors), we ignore the variables X₀ and R₀ in the rule. FIG. 3, as shown, presents examples of the rules derived from the interfaces of classes A and C.

A second rule projects an object of a particular type from a vector of output objects. The operator #ᵢ takes a tuple and projects the i^{th} entry of the tuple:
Tᵢ(Rᵢ)←T₀* . . . * Tₙ(R)
Rᵢ=#ᵢ(R), 0≦i≦n

This rule specifies that if R is a vector of objects of type T₀ * . . . * Tₙ then #ᵢ(R) is an object of type Tᵢ. For example, if R≐ [symbol] o₁, o₂z,902 is a vector of objects of type A*C, then #₀(R) is the object o₁ of type C.

Let T represent the set of types in our programming language. A database of objects can be thought of as a mapping D from T to sets of objects having type T. Suppose that the database already contains objects o₀, . . . , oₖ, where object oᵢ has type Tᵢ. Then we can execute the first and second rules (given above) in order to obtain the object oₖ₊₁ and add it to the set of objects of type Tₖ₊₁ in D. At the same time, the rules also add the objects o₀, for 0≦i≦k obtained after executing the method m to the set of objects of type Tᵢ. Initially, in an exemplary embodiment a database D used to hold plans, the plans used to generate objects is populated with default objects for each type T. For primitive types such as integers, a set of default values in some range (e.g. {−5, . . . , 5}) is added to D as objects of type integer. For any other type T, null is added to objects of type T in D. These objects are denoted as base objects.

### Plans

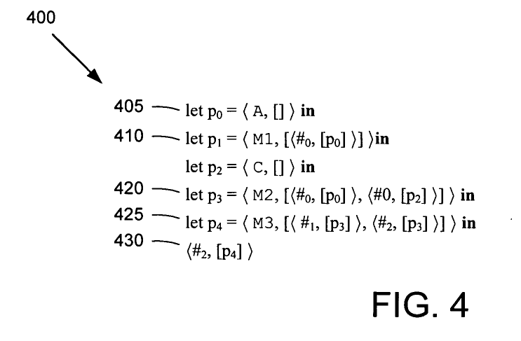

A plan denotes a derivation using the first and second rules given above. Intuitively, a plan of type T (where T can be a compound type T₀, . . . , Tₖ₊₁) yields an entity of type T. The entity can be an object if T is a type in the program, or a vector of objects if T is a compound type. A plan P of type T consists of the following tuple: [symbol] Trans, [Inp₁, . . . , Inpₖ] [symbol] , where Trans is either a transformer (a method or a constructor in the program) or the projection operator #ᵢ, for a given i. [Inp₁, . . . , Inpₖ] is a list of input plans, such that type Inpⱼ is the type of the j^{th} argument to Trans. To illustrate, consider the example C# classes in FIG. 3. An example of a plan for creating an object of class A 302 can be obtained, as shown with reference to FIG. 4.

Observe that the plans p₁ 410 and p₃ 420 share the plan p₀ 405, and two arguments of p₄ 425 share the plan p₃ 420. In general, a plan can be thought of as a directed acyclic graph (DAG), where a plan can be shared by multiple plans.

### Executing a Plan

A plan denotes a template or recipe for constructing an object of a given type. The actual object is obtained only when the plan is executed. Execution involves creating a linear sequence of method invocations from the plan's directed acyclic graph (DAG) that can be executed. There are various ways to create the linear sequence—each will lead to the creation of different objects. For example, the order of evaluation of the list of input plans (e.g. left to right or right to left) for a given plan may influence the objects that act as inputs to the transformer. Also, if two plans p₁ and p₂ share a plan p, then the order that the two plans are executed also determines the objects being created. This is because, at a minimum, the transformer of each plan may potentially update the object it takes as an argument. In an exemplary implementation, plans are executed as follows:

To execute a plan p≐ [symbol] m, p₁, . . . , pₖ [symbol] where m is a method or constructor, p₁, . . . , Pₖ is recursively executed in left to right order. Another embodiment executes plans from right to left order, while yet another embodiment determines execution order based on some other criteria. The method or constructor m is then applied on the resultant objects o₁, . . . , oₖ obtained by executing the input plans. If a plan is shared by more than one plan, it will be re-executed except for the following case: If two plans pᵢ≐ [symbol] #ᵢ, q [symbol] and pⱼ≐ [symbol] #ⱼ, q [symbol] appear in the input of a plan p that share the same plan q, q is only executed once with the output projected to obtain oᵢ and oⱼ. This allows objects oᵢ and oⱼ to be passed that are correlated by the execution of the same plan.

Consider the execution of the plan 430 shown in FIG. 4. The execution of the plan to realize [symbol] #₂, [p4] [symbol] will produce the following code sequence:

/* Execute p0 */
A v1 = new A( );
/* Execute p2 */
C v2 = new C( );
/* Execute p3 */
C v3 = v1.M1(v2);
/* Execute p4 */
A v4 = v2.M3(v3);

The object v4 in the above code sequence is the desired object of type A. Note that the plan p1 was never executed because it does not belong to the ancestors of p4 in the above plan. Also, observe that p3 is only executed once even though p4 shares two of the outputs of p3.

### Exploring with Plans

Plans are the language used for describing object states. To search the state space of an application, we search the space of plans that can be created through the application's public interface. An exemplary embodiment performs the search in a structured way (such as exhaustively exploring the space of plans of a given size). However, for very large programs with hundreds of method invocations, another exemplary embodiment uses a randomized exploration strategy.

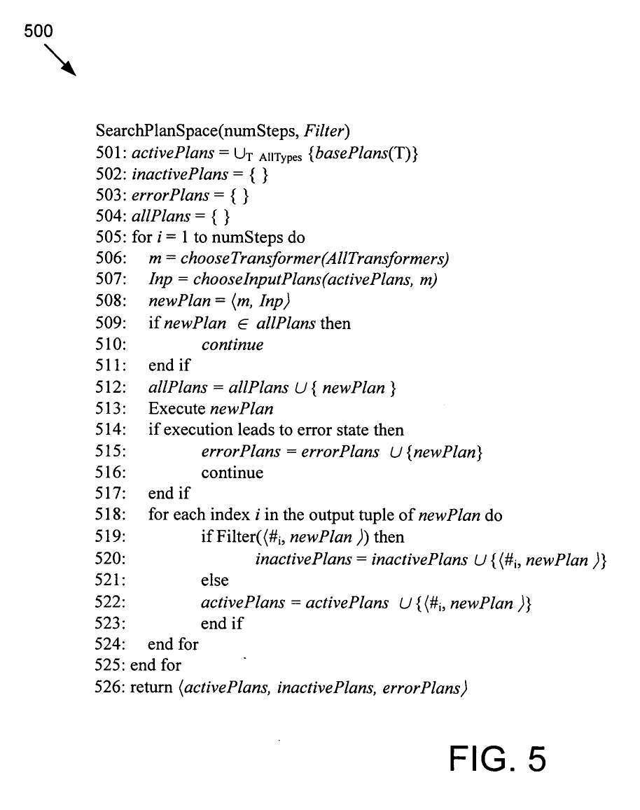

FIG. 5 is pseudo-code showing an exemplary high-level embodiment of a search algorithm that may be used. The search algorithm maintains four sets of plans:
1. activePlans: Plans that can be executed to construct objects of a given type.
2. inactivePlans: Plans that will not be executed to construct objects. These plans are retained only because they serve as witnesses for the methods they covered.
3. errorPlans: Plans whose execution result in an error or a potential error state.
4. allPlans: The set of plans created.

The term AllTypes denotes the set of all types in the program to explore, and AllTransformers denotes all public transformers present in the program. Other implementations can use subsets of all possible types and/or subsets of all possible transformers. The inputs to the algorithm in this exemplary embodiment specifies the number of attempts to create plans (numSteps) and a predicate Filter (Filter) that classifies plans as inactive or active.

Lines 501-504 initialize the set of plans. For each step in the exploration, the algorithm chooses among the program's transformers using chooseTransformer at line 506. The method chooseTransformer can choose a plan nondeterministically, or deterministically. At line 507 a list of input plans is chosen (either deterministically or nondeterministically) from the activePlans set, and at line 508 a new plan newPlan is created. After constructing newPlan, at lines 509-511, the algorithm checks if an equivalent plan (a plan with the same transformer and identical list of input plans) has already been created. If so, the algorithm tries again to create a new plan. Otherwise, the new plan is added to the set of all plans at line 512. Next, at line 513 the newly-created plan is executed. After the plan has been executed, we first check if the execution raises any exception or potential exception, at line 514. If so, the plan is added to errorPlans at line 515. Otherwise, at the “for” loop on lines 518-523, each position i in the output tuple of newPlan is used sequentially to create the plan [symbol] #ᵢ, newPlan [symbol] . Using the predicate Filter on this plan (line 519), the plan is checked to see if its behavior is interesting enough to place it in the activePlans set at line 522, or whether it is to be discarded—placed in the inactivePlans set at line 520.

### Pruning the Plan Space

Pruning is accomplished by flagging a plan as inactive when it is heuristically determined to be useless as an input to new plans. This is done, preferentially, by applying a set of filters. Lines 519-523 in FIG. 5 use filters to determine whether a plan will be added to the set of inactivePlans or the set of activeplans. A filter, in an exemplary embodiment, inputs a boolean expression and outputs objects of the plan. Filters can vary in complexity ranging from a nullness check on an object, to a full specification. An exemplary embodiment defines three kinds of filters defined further below: null pruning, equality pruning, and an exceptional behavior filter. If all filters returns true, the plan is added to the activePlans set, at line 522; otherwise, at line 520 it is added to the inactivePlans set.

Null Pruning

Null is a special value in object-oriented programs. Null dereference exceptions caused by using null as an input parameter to a method are often not interesting, and usually point to the absence of null check on the arguments. However, when a null dereference exception occurs in the absence of any null value in the input, it often indicates some internal problem of the method. A null filter returns true if the object is null, and false otherwise. An exemplary embodiment enforces online that plans do not pass null as a parameter.

Equality Pruning

This heuristic determines if the state of an object has changed. An exemplary embodiment using the language C# invokes the Equals method on objects to determine whether the state of an object has changed. Other embodiments in C# and other embodiments in other object-oriented languages use different heuristics to determine if an object has changed state. Another exemplary embodiment determines if any object within the program or a subset of the program has changed state. The exemplary heuristic works as follows:
1. Create the input objects to the plan's transformer by, in an exemplary embodiment, executing the plans that yield the inputs. Do not invoke the transformer, but save the input objects (called prestate objects).
2. Create (again) the input objects to the plan's transformer. This time, invoke the transformer on the inputs. The resulting objects can be called poststate objects.
3. Check if each prestate object is in the same state as its associated poststate object. One implementation involves calling the C# method “Equals” on each prestate object and its associated poststate object. If the class of the given object has overridden the default implementation of Equals, and the comparison returns true, the object is considered redundant, as the state has not changed.
4. If the poststate object is redundant, return false. Otherwise, return true.

Other embodiments accommodate more sophisticated computations to determine object equality.

Exceptional Behavior Filter

If the execution of a plan leads to an exception, then no plans are created for any of the output objects of this plan as the plan would lead to an exception before creating the object. Rather, the plan is added to the errorPlans set, as shown in FIG. 5 at 514-515. In one embodiment, the errorPlans set is inspected when the search algorithm documented in FIG. 5 is completed to find a subset of potentially error revealing plans, based on the types of exceptions that were raised. Examples include plans that lead to an assertion violation, show non-terminating behavior, throw null reference exceptions, index out of range exceptions, and those that lead to illegal memory accesses.

### Extending Plans

The above strategies prune potentially-redundant plans, which results in a smaller search space. The plans remaining are, ideally, extended to produce increased test coverage. The list below discusses at least some methods of selecting a transformer to apply to a plan that was chosen to be extended.
Uniform selection: select a transformer uniformly at random from the set of all the public transformers.
Round robin: create a circular list containing all transformers, maintaining a pointer to the current transformer. At each step, select the current transformer, and set the pointer to the next one in the list.
Coverage-based: track the cumulative code coverage achieved for each transformer during the search process. (Recall that a transformer represents executable code, so its coverage is equivalent to the code that is executed by it.)

In one embodiment, at each search step, a transformer is selected partially randomly, favoring undercovered transformers ( that is, those having a higher number of uncovered statements or branches). To implement this technique, we assign each transformer R a weight w(R)=1/max(cov_{arc}(R), c), where cov_{arc}(R) is the transformer's arc coverage ratio achieved so far (1 for fully-covered transformers, 0 for uncovered transformers); c is a small positive constant (c<<1) that prevents arbitrarily large weights. A fully covered transformer has weight 1 and an uncovered transformer has the largest weight possible, 1/c. The probability of selecting transformer R among a set of transformers {R₀, . . . , R_{K}} is

$$w ( R ) / {\sum }_{i = 0}^{K} w ( {R}_{i} ) .$$

Frequently-used classes: Instead of assigning weights to transformers directly, we can assign weights to the classes in the application, and favor transformers that create objects of classes with larger weights. This heuristic favors transformers that create objects of classes that are frequently mentioned throughout the application, that is, appear often as return values or parameters to method invocations. One instantiation uses a counting scheme to determine frequently-used classes: the number of times each class is mentioned in the public interfaces of the target application (as a parameter or return value) is counted, and each class T is associated with its occurrence count count(T).

The heuristic defines a transformer's weight as the sum of the weights of the transformer's goal elements; for example, the transformer R with an output vector of type T₀* . . . * Tₖ has weight

$$w = {\sum }_{i = 0}^{K} count ( {T}_{i} ) .$$

The probability of selecting transformer R from {R₀, . . . , R_{K}} is again

$$w ( R ) / {\sum }_{i = 0}^{K} w ( {R}_{i} ) .$$

Another nondeterministic choice in the algorithm is the selection of input plans to a transformer. Below, and without limitation, are two selection embodiments—uniform selection and selection favoring smaller inputs.
Uniform selection: To select a plan with type T for an input, we choose a plan with type T from the set activePlans uniformly at random.
Selection favoring smaller inputs; A type-compatible plan is selected at random, favoring plans with smaller plan size.

The plan size of a plan is the number of transformers used in the plan. This distribution can be thought of as favoring breadth over depth in the search. By favoring smaller inputs, the strategy leads the search towards rejecting longer plan sequences, thus spending more time exploring a larger number of smaller plans. Other implementations may use different search strategies, such as those that use breadth-first strategies, by, for example, favoring longer transformers over shorter ones.

### Exemplary Methodfor Testing an Object-Oriented Program

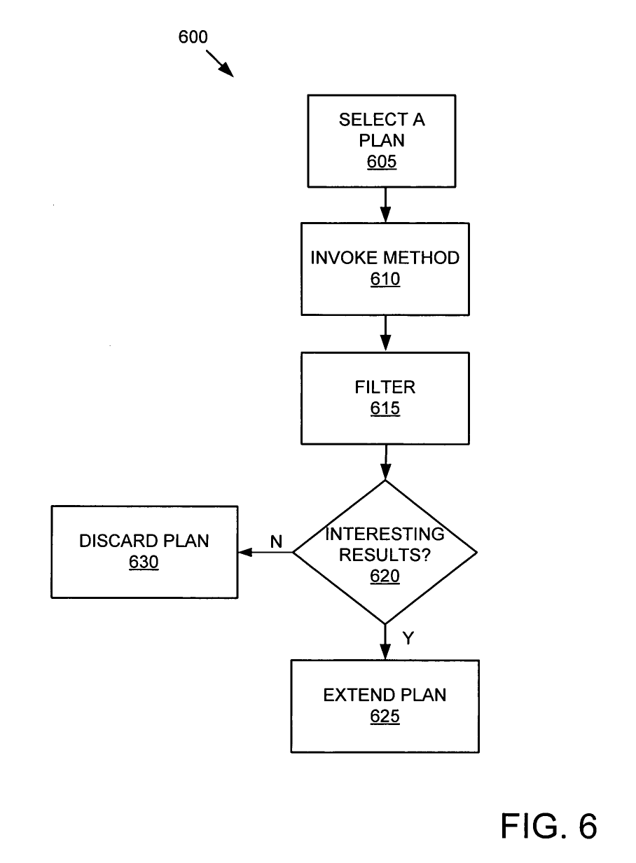

FIG. 6 describes an exemplary method 600 used to construct test inputs used to test object-oriented programs. Object oriented programs are those, as a minimum, written using the idea of classes, such as the languages C++, Java, C#, among many. At process block 605 a first plan is selected. The plan can be selected randomly from the set of all plans, can be selected from a subset of plans based on some criteria, the criteria including coverage-based criteria or criteria that favors plans with objects whose classes are more (or less) frequently used. Plans can also be selected that require less or more CPU time to run, or can be selected based on other criteria.

The plan comprises a method of an object. In an exemplary embodiment, the plan comprises a template for producing an object of a specific type, and may optionally include a method appropriate for the object. Information obtained, for example, by executing the public interface code that mutates the objects within an application to be tested, can be used to generate the plans. This information may be obtained online.

At process block 610, a method associated with the plan is invoked, if included. In some embodiments, a series of methods are invoked until the last called method outputs an object of the desired types. At process block 615 filtering is done to determine if the plan, as represented by the method and its object have produced interesting results.

At decision block 620 it is determined if the results are interesting. Interesting results are those that lead to unexplored states, such as the method using portions of the application code that had yet to be tested. Interesting results are also those that lead to state changing somewhere within the program. Sometimes, only state changing associated with the method is considered. This would be, for instance state changing in a receiver, a parameter, or an output of the method. Uninteresting results are those that, for example, lead to error states such as generating a null value or throwing an exception, which do not produce a state change, or that have previously been sufficiently tested.

If results are deemed interesting, then, at process block 625, the plan that led to these interesting results is extended. If the results are deemed uninteresting, then, at process block 630, the plan is not extended. Even if the plan is not extended, the plan may be saved in an appropriate location, to, for example, give a record of which plans have previously been used, which code sections have been previously covered, and so on.

Even though plans that lead to error states are not extended, the error states that are located may very well be themselves interesting, that is, they can show certain classes of errors, that portions of the application program code have been tested, and so on. As has previously been discussed, the same is true of null states. Even though such null states are not of interest for extending a plan, the presence of such a value may indicate some internal error lurking within the called method. Therefore, such null states may be saved for further study.

The plans that are determined to be interesting are extended by, at a minimum, changing one of the parameters used by the latest method, choosing new methods of the object, choosing to run sections of the code that initially led to the interesting behavior, choosing to more closely examine a receiver of the method, a parameter of the method, or an object returned from the method, choosing to add a method to the initial plan, and so on.

At any rate, in an exemplary embodiment, at least one new plan or a series of plans consisting at a minimum of the original method-object pairs, are created to be used in the testing. In an exemplary embodiment, a new method is chosen, and code sufficient to invoke it along with the original plan code is included in the new plan. In some embodiments, the new plan is immediately run. In other embodiments, the plan is added to all available plans. Next, one of the available plans is chosen to be run. The next plan may be chosen randomly, or may be chosen following some predetermined search scheme, such as depth-first or breadth-first. This process stops when a predefined event happens, such as preset number of plans has been run, a preset amount of time has passed, and so on.

In an alternate embodiment, the program in its current state is extended by choosing a different method, choosing inputs for the method, and then continuing calling the different method on the object, by calling the same method with a different parameter, by further exploring any inheritance of the object, including but not limited to multiple inheritance paths and virtual inheritance paths, if the underlying language possesses such functionality, and so forth. Choosing the extension for the program is preferably done automatically. Different strategies can be chosen, previously discussed to extend the program, such as randomly selecting a transformer for the current object, selecting a new object to introduce into the existing program, and so forth.

### Exemplary System for Constructing Test Inputs

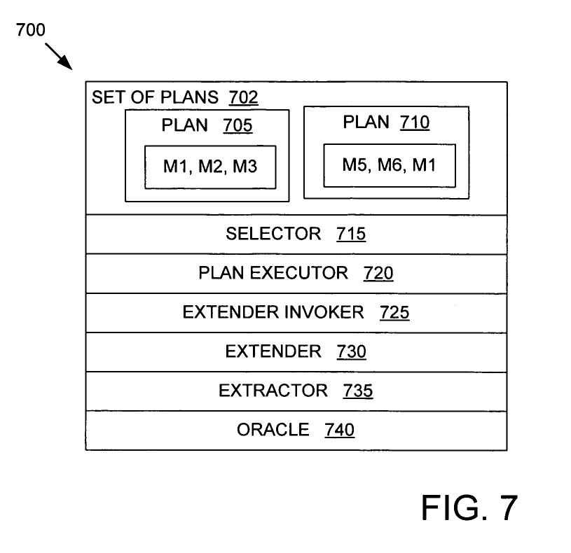

FIG. 7 describes a system 700 for constructing test inputs used in testing an object-oriented program. The test, in an exemplary embodiment is performed without requiring modification of the original code, and is created using the public interface. The system comprises an optional extractor 735 which extracts the public interface from a program or application that is to be tested. The system also comprises a set of plans 702. Each of these plans 705, 710 describes a template for building an object of a type. A plan may consist of a method that calls an object to produce an object of a specific type, a plan may describe a series of method calls, each call with associated parameters, which leads to an object of a specific type, a plan may describe an object with a type, a variable, or another type of program construct, and so on.

A selector 715 is also included. The selector chooses the next plan from the set of plans. The next plan may be chosen randomly, or may be chosen using some other criteria. For example, the next plan may be chosen based on having a feature in common with the previous plan; for example, the selector may favor plans that share at least one method with the current plan, share an object with the current plan, etc. Other methods of selection previously discussed may also be used.

A plan executor 720 is also provided. It executes the section of application code specified by the plan. This may involve invoking the methods contained within the plan. A filter 725 determines if the plan just executed leads to a behaviorally interesting, which may include behaviorally diverse, state. In some embodiments, a state is considering interesting if the state of the object that the method was invoked upon has changed internally. Other embodiments consider all the inputs and outputs to the method, including the method's receiver, any input parameters of the method, and any return value, and consider the state interesting if any of them have changed, or if any of them have changed in new or unexpected ways.

An extender invoker 725 invokes the extender 730 when the filter determines that an invocation of the object of the plan changes state of the program. The extender 730 gives more input to the test program, allowing it to continue running by adding a method call to the existing program invocation, by modifying at least one parameter to the method and then calling the method using the existing object, object which has been created previously, or by invoking a new object, by using a different object to be the method's receiver in a new invocation of the method, and so on.

If a potential error state is returned when the plan or a subsequent extension of the plan is executed, the included Oracle 745 can be used to determine if the error state itself has interesting error-revealing behavior, as discussed above, such as null reference exceptions, index out of range exceptions, non-terminating behaviors, and illegal memory access exceptions. Such behaviors might be then output as a test class that can themselves be compiled to reproduce the behavior.

### Exemplary Method for Testing an Object-Oriented Program

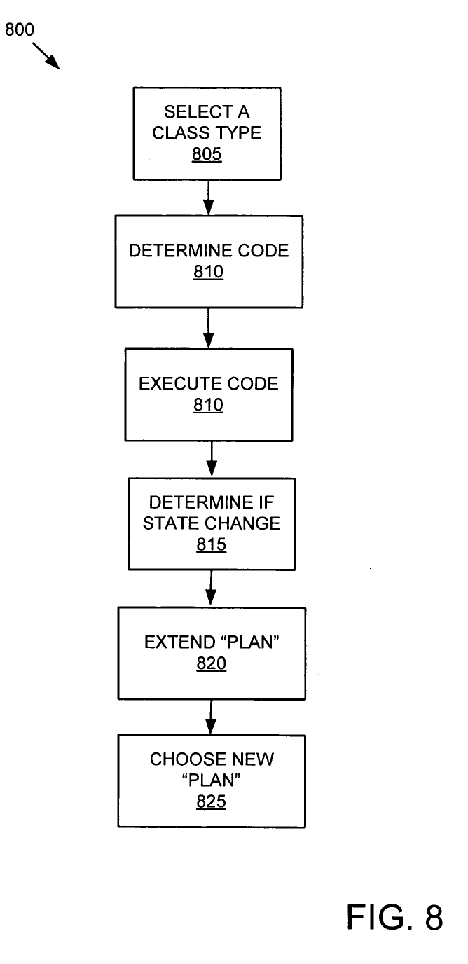

FIG. 8 describes an exemplary method 800 used to test applications written in object-oriented languages. At process block 805 at least one class type in the application is selected. Object-oriented programs may have many more types than is immediately obvious. For example, a class which inherits another class should be considered to have potential objects as types not only of the types defined in its class, but also of each of the inherited types as well. Essentially, all objects of types reachable from a class should be considered objects of that class. At process block 810, the portion of the code necessary to invoke an object of the class type is determined—this is the “plan.” The portion of the code determined may be the minimum subset of method calls necessary to invoke the object, or may be a larger selection of code. There may be many ways to invoke a given object, and of the possible ways, one of them may be chosen at random, or a different method may be used to determine which way, among the ways possible, is chosen. Also chosen, in at least some embodiments, is a method associated with the class. This method may be chosen randomly or may be chosen using some other heuristic such as by how frequently the method is used in the given program. If the method has inputs, these inputs, too, are chosen, either randomly or using some other predetermined heuristic.

At process block 815 the portion of the code determined at process block 810 is run, which should invoke the object. The object, as has previously been discussed, contains state information associated with it. If invoking the object changed state information in an interesting way, either in the object itself, or in objects associated with the invocation of the object, then the object is considered interesting, and the method involved, objects called as parameters, return objects, etc. are also considered interesting, and, will be further examined, as shown at process block 815. One heuristic for determining if state has changed, equality pruning, is discussed above within the section “Pruning the Plan Space.” At process block 820, the plan run to invoke this object is extended. This extension may comprise adding a new method to the existing plan, choosing a new input or inputs for the existing method, etc. In some embodiments, the original object state is cached or otherwise stored after the plan is run, and then the extension of the plan is run from the cached state. This extended plan is then checked for interesting behavior at 815, and the process continues.

At process block 825, a new plan is chosen. In some embodiments, a series of plans is created initially, each plan being, at a minimum, sufficient code to invoke an object. As plans are run and are extended, some plans of necessity become larger than others, that is, they contain more transformers (a method or a constructor). Of the existing plans, plans can be chosen preferentially to perform a depth-first search by favoring longer plans, plans can be chosen preferentially to perform a breadth-first search by favoring shorter plans, or another plan selection method, such as one that is completely random, can be used.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A computer-implemented method of testing an object-oriented program comprising:
selecting a first plan, wherein a plan comprises a first method;
invoking the method; and
filtering program state of the invoked first method to determine if state of an object associated with the method changed;
if the filtering determines that the state of the object associated with the method changed, then
extending the first plan.

2. The method of claim 1 wherein there are multiple plans, and wherein the first plan is selected randomly.

3. The method of claim 1 further comprising creating at least one plan by selecting a method from among publicly available methods in the program and by determining a constructor for an object which calls the method.

4. The method of claim 1 wherein filtering further comprises at least one selected from the group consisting of: determining if output is null, and determining if invoking the method caused an error.

5. The method of claim 5 wherein an object associated with the method comprises at least one of a receiver of the method, a parameter of the method, or an object returned from the method.

6. The method of claim 1 wherein extending the plan further comprises choosing a second method to be used in conjunction with the first method, the first and second method comprising a next plan.

7. The method of claim 6 wherein the choosing a second method further comprises selecting from at least some available methods of classes in the program using at least one selected from the group consisting of: a round-robin scheme, selecting favoring high coverage, selecting randomly, or selecting favoring a method from a frequently-used class.

8. The method of claim 7 wherein selecting favoring a method from a frequently-used classes comprises counting the frequency a class occurs as a parameter or as a return value in a listing of the program, and favoring methods associated with a class with a high frequency.

9. The method of claim 7 wherein selecting favoring high coverage comprises selecting the method with a high potential for having code statements that have not previously been executed.

10. The method of claim 6 wherein choosing a second method further comprises randomly choosing at least one input for the second method.

11. The method of claim 10 wherein a second plan is chosen from a group of plans based on number of method calls.

12. The method of claim 1 wherein if filtering determines that the method does not change the state of the object, then saving the first plan as an inactive plan.

13. The method of claim 1 further comprising creating a third plan which comprises selecting a class object constructor from among the publicly-available classes of the program.

14. An automated computer system for constructing test inputs used to test an object-oriented program comprising:
a set of plans, at least one plan comprising at least one method call to create an object; the at least one plan operable as test input;
a selector for selecting a selected plan from the set of plans;
a plan executor for executing the selected plan;
a filter for determining if the selected plan should be extended; and
an extender for creating at least one extended plan, the extended plan comprising the at least one method call and at least one subsequent method call.

15. The system of claim 14 wherein the extender further creates the extended plan by selecting at least one input for the at least one subsequent method call.

16. The system of claim 14 wherein the extender chooses the at least one subsequent method using at least one selected from the group consisting of: a round-robin scheme, selecting favoring high coverage, selecting randomly, or selecting favoring a method from a frequently-used class.

17. The system of claim 14 further comprising an extender invoker, which invokes the extender when the filter determines that an invocation of the plan changes state of the program.

18. The system of claim 14 further comprising an extractor, which extracts a public interface from the program, wherein at least one plan is created using information from the extracted public interface.

19. The system of claim 14 further comprising an oracle which determines if a plan is potentially error-revealing.

20. A system for testing an object-oriented application comprising:
means for randomly selecting at least one class type in the application;
means for randomly selecting at least one method of the class;
means for determining code sufficient to invoke the method;
means for executing the determined code thereby invoking the method;
means for filtering output of the invoked method to determine if the output produced a changed state; and
means for extending the determined code by randomly selecting at least a second method in the application, and determining code sufficient to invoke the first and second methods.
